(19) United States
(12) Patent Application Publication
(10) Pub. No.: US 2022/0236073 A1
(43) Pub. Date: Jul. 28, 2022

(54) METHOD FOR CREATING A UNIVERSALLY USEABLE FEATURE MAP

(71) Applicant: Robert Bosch GmbH, Stuttgart (DE)

(72) Inventors: Hanno Homann, Hannover (DE); Marco Lampacrescia, Stuttgart (DE); Peter Biber, Tuebingen (DE); Sebastian Scherer, Tuebingen (DE)

(21) Appl. No.: 17/596,131

(22) PCT Filed: May 7, 2020
(86) PCT No.: PCT/EP2020/062702

§ 371 Date: Dec. 3, 2021

(30) Foreign Application Priority Data
Jun. 7, 2019 (DE) 10 2019 208 384.6

(51) Int. Cl. G01C 21/00; G01S 17/89; G01S 17/931

(52) U.S. Cl. CPC G01C 21/3807; G01C 21/3833; G01S 17/931; G01C 21/3878; G01S 17/89; G01C 21/3867

(57) ABSTRACT

A method for creating digital maps with the aid of a control unit. Measured data of surroundings are received during a measuring run. A SLAM method is carried out for ascertaining a trajectory of the measuring run based on the received measured data. The received measured data are transformed into a coordinate system of the trajectory. The transformed measured data are used for the purpose of creating an intensity map. Features are extracted from the intensity map and are stored in a feature map. A method for carrying out a localization, a control unit, a computer program as well as a machine-readable memory medium are also described.

### FIELD

The present invention relates to a method for creating digital maps and to a method for carrying out a localization. In addition, the present invention relates to a control unit, to a computer program and to a machine-readable memory medium.

### BACKGROUND INFORMATION

Localization is an essential functional component for the automated operation of vehicles and robots. With the aid of localization, it is possible to ascertain the exact position of the vehicle or of the robot within a map or surroundings. Based on the ascertained position, control commands may be generated in such a way that, for example, trajectories are navigated or tasks are carried out.

In applications without access to GNSS data, in particular, the so-called SLAM method is applied for simultaneous localization and mapping. For this purpose, measured data, for example, from LIDAR sensors, are collected and evaluated for generating a map. In a subsequent step, a position within the map is able to be determined.

A problem with the SLAM method is the application in dynamic or semi-static surroundings. Such surroundings may, for example, be present in storage areas, construction sites, intralogistics or in container ports. Due to a regular movement of objects, a created map temporarily loses its validity. A regular updating of such maps requires great effort in terms of measuring and evaluation. The updated map must, in particular, be provided to all users, which requires an infrastructure for providing high volumes of data.

### SUMMARY

An object of the present invention is to provide a method for creating a universally useable digital map with reduced data usage.

This object may be achieved with the aid of the present invention. Advantageous embodiments of the present invention are disclosed herein.

According to one aspect of the present invention, a method is provided for creating digital maps with the aid of a control unit. In accordance with an example embodiment of the present invention, in one step, measured data of surroundings are received during a measuring run. The measuring run in this case may be an arbitrary trip. Measured data may preferably also be collected by at least one sensor when stopped or parked. The corresponding measured data may subsequently be received and processed by the control unit.

Based on the received measured data, a SLAM method is carried out for ascertaining a trajectory of the measuring run. In the process, a self-localization based on a series of measured data is carried out, the respective positions during the measuring run forming a trajectory.

In one further step, the received measured data are transformed into a coordinate system of the trajectory. The received measured data may, for example, include positions and/or distances relative to a sensor. These relative coordinates may subsequently be transformed, for example, into an absolute coordinate system of the trajectory. Such a coordinate system may, for example, be a Cartesian coordinate system.

The transformed measured data are used for the purpose of creating an intensity map. For example, an intensity of reflected beams of one or of multiple LIDAR sensors or of radar sensors may be ascertained and stored in the form of a map that includes a received radiation intensity.

Features are subsequently extracted from the intensity map and stored in a feature map. The features may preferably be detected in the intensity map. This process may take place, for example, using an algorithm for pattern recognition. The pattern recognition may also be carried out by a neural network, which has been previously trained accordingly. The pattern recognition may, for example, be carried out manually by an authorized person or in an automated manner. In addition, a pattern recognition carried out in an automated manner may be enabled or confirmed by the authorized person.

The pattern map may preferably be universally useable. The pattern map may, in particular, be useable in a sensor-independent or sensor-overlapping manner, so that features may be extracted from differently ascertained measured data and used for localization based on the feature map.

According to one further aspect of the present invention, a method is provided for carrying out a localization, in particular, with the aid of a control unit. In accordance with an example embodiment of the present invention, in one step, measured data of surroundings and a feature map are received. The measured data may be ascertained by one or multiple sensors. Such a sensor may, for example, be a camera sensor, a LIDAR sensor, a radar sensor, an ultrasonic sensor and the like. The sensor may, in particular, differ from a sensor that has been used to create the feature map.

In one further step, features in the received measured data are recognized and extracted. At least one extracted feature for ascertaining a position is subsequently compared with features stored in the feature map. In a successful comparison of at least one feature, the position of the sensor or of a vehicle that carries out the measurement with the aid of the sensors is determined.

According to one further aspect of the present invention, a control unit is provided, the control unit being configured to carry out the method. The control unit in this case may be an on-board control unit, which is integrated into a vehicle control system for carrying out automated driving functions or which is connectable to the vehicle control system. Alternatively or in addition, the control unit may be designed as an off-board control unit such as, for example, a server unit or a cloud technology.

According to one aspect of the present invention, a computer program is also provided, which includes commands which, when the computer program is executed by a computer or a control unit, prompt the computer to carry out the method according to the present invention. According to one further aspect of the present invention, a machine-readable memory medium is provided, on which the computer program according to the present invention is stored.

The control unit in this case may be installed in a vehicle. At least one measuring run may, in particular, take place in a vehicle including the control unit. The vehicle in this case may be operable according to the BASt Standard in an assisted, semi-automated, highly automated and/or fully automated or driverless manner. According to one alternative or additional embodiment, the vehicle may be a drone, a watercraft and the like. As a result, the method may be used on roads such as, for example, expressways, country roads, urban areas, as well as away from roads or in off-road areas. The method may be utilized, in particular, in buildings or warehouses, in underground spaces, parking decks and parking garages, tunnels and the like.

The at least one sensor for ascertaining measured data may be part of a surroundings sensor system or of at least one sensor of the vehicle. The at least one sensor may, in particular, be a LIDAR sensor, a radar sensor, an ultrasonic sensor, a camera sensor, an odometer, an acceleration sensor, a position sensor and the like. The sensors may, in particular, be used alone or in combination with one another. In addition, sensors such as, for example, acceleration sensors, radar sensors, LIDAR sensors, ultrasonic distance sensors, cameras and the like may also be used to carry out an odometric method.

With the aid of the method according to the present invention, it is possible, in particular, to ascertain and extract static features of surroundings. Such features may, for example, be roadway markings, geometric shapes of buildings, curbs, roads, arrangement and position of traffic lights, guide posts, roadway boundaries, buildings, containers and the like. Such features may be detected by different sensors and may be used for a localization. For example, extracted features from measured data of a LIDAR sensor may also be detected by camera sensors and compared with one another for the purpose of localization. Thus, a universally useable feature map may be created, which is useable by different vehicles and machines. For example, such a feature map may be used by passenger vans, transport units, manipulators and the like for a precise localization.

The marking map may preferably be created in a first step and subsequently used for localization tasks. The marking map may, in particular, be utilized for localization and control tasks of vehicles or robots operated in an automated manner.

Since the features of the feature map may be present as geometric figures, lines or points, the features are storable in a minimal data size in the form of coordinates or vectors. In this way, it is possible to reduce the volume of data required when providing the feature map to vehicles or robots.

According to one exemplary embodiment of the present invention, the feature map is stored as the digital map or as a map layer of the digital map. In this way, the feature map may be used in a particularly flexible manner. An existing map may, in particular, be upgraded by the feature map or designed as a digital map that includes a minimal memory requirement.

According to one further exemplary embodiment of the present invention, the received measured data are present as a point cloud and are assigned to a grid made up of a plurality of cells. Mean values of the measured data of each cell are preferably formed to create the intensity map. The cells of the digital map may, for example, be pixels, pixel groups or polygons. By forming the mean values, it is possible to compensate for local inconsistencies and fluctuations in the measured values. The measured values may be formed, in particular, by reflected or backscattered and subsequently detected beams of a radar sensor and/or of a LIDAR sensor.

According to one further specific embodiment of the present invention, an elevation map is created from the received measured data, a weighted mean value being formed from the measured data of each cell and of the adjacent cells for creating the elevation map. In this way, additional pieces of information may be extracted from the ascertained measured data and used in the creation of the feature map.

According to one further exemplary embodiment of the present invention, pieces of information from the created elevation map are received and stored in the feature map for determining an elevation of the extracted features. In this case, the elevation map may be superimposed with the feature map and the corresponding attributes or pieces of information of the elevation map may be transferred to the feature map. For this purpose, the elevation or the increase of the intensities at the positions of the features, for example, may be adopted by the respective features. This process may preferably be carried out in an automated manner, each cell of the elevation map being compared with each cell of the feature map.

According to one further specific embodiment of the present invention, the extracted features are stored as universally ascertainable features in the feature map. According to one advantageous embodiment, the features are extracted and stored as geometric shapes, lines, points and/or point clouds and the like. Thus, objects, markings and characteristic or distinctive shapes may be extracted from the measured data of the surroundings and used for carrying out localizations. In this way, a plurality of static features may, in particular, also be ascertained in dynamic surroundings and may be used for precisely ascertaining a position. In the process, the features may be ascertained in an essentially sensor-independent manner, so that the marking map is universally useable.

According to one further exemplary embodiment of the present invention, the received measured data are designed as position data and stored in a position diagram. The ascertained position in the case of successfully compared features is preferably stored as a new measured value in the position diagram. The feature map may be used for ascertaining a position, for example, of a vehicle or of a robot. In this case, the respective instantaneous position is ascertained along a route, for example, at defined temporal intervals and stored in a position diagram or a position map. A traveled distance or trajectory may be represented based on the position diagram. If a feature is found again in the feature map, then the vehicle or the sensor that ascertained the measured data may be assigned a position within the feature map. This position is subsequently stored as a unique measurement in the position diagram.

According to one further exemplary embodiment of the present invention, the measured data are ascertained by at least one sensor, which differs from at least one sensor for creating the feature map. The extracted features may be present preferably in an abstracted form and may thus be universally readable or comparable. Such a form of the features may be present, for example, as coordinates in text form. The features within the coordinates may include, in particular, a start point, an end point, intermediate points, directions, lengths, elevations and the like. These pieces of information may be stored with a particularly low memory space requirement and may be used for carrying out comparisons.

### BRIEF DESCRIPTION OF THE DRAWINGS

Preferred exemplary embodiments of the present invention are explained in greater detail below with reference to highly simplified schematic representations.

FIG. 1 schematically shows a representation of an arrangement for illustrating an example method according to the present invention,

FIG. 2 schematically shows a diagram for illustrating the method for creating digital maps according to one exemplary embodiment of the present invention.

FIG. 3 schematically shows a diagram for illustrating the method for carrying out a localization according to one exemplary embodiment of the present invention.

FIG. 4 schematically shows an intensity map.

FIG. 5 schematically shows an elevation map.

FIG. 6 shows a perspective representation of a feature map.

### DETAILED DESCRIPTION OF EXAMPLE EMBODIMENTS

FIG. 1 schematically shows a representation of an arrangement 1 for illustrating a method 2, 4 according to an example embodiment of the present invention.

Arrangement 1 includes two vehicles 6, 8. Alternatively or in addition, arrangement 1 may include robots and/or additional vehicles. According to the exemplary embodiment represented, a first vehicle 6 is used for carrying out method 2 for creating digital maps, in particular, marking maps. Second vehicle 8 is schematically illustrated in order to illustrate a method 4 for carrying out a localization within the digital map.

First vehicle 6 includes a control unit 10, which is connected in a data-transferring manner to a machine-readable memory 12 and to a sensor 14. Sensor 14 may, for example, be a LIDAR sensor 14.

First vehicle 6 is able to scan surroundings U and to generate measured data with the aid of LIDAR sensor 14. The ascertained measured data may subsequently be received and evaluated by control unit 10. A feature map created by control unit 10 may be provided to other road users and to vehicle 8 via a communication link 16. The feature map may be stored in machine-readable memory medium 12.

Second vehicle 8 also includes a control unit 11. Control unit 11 is connected in a data-transferring manner to a machine-readable memory medium 13 and to a sensor 15. Sensor 15 according to the exemplary embodiment is a camera sensor 15 and is also able to ascertain measured data of surroundings U and to transfer them to control unit 11. Control unit 11 is able to extract features from the measured data of surroundings U and to compare them with features from the feature map, which have been received by control unit 11 via communication link 16.

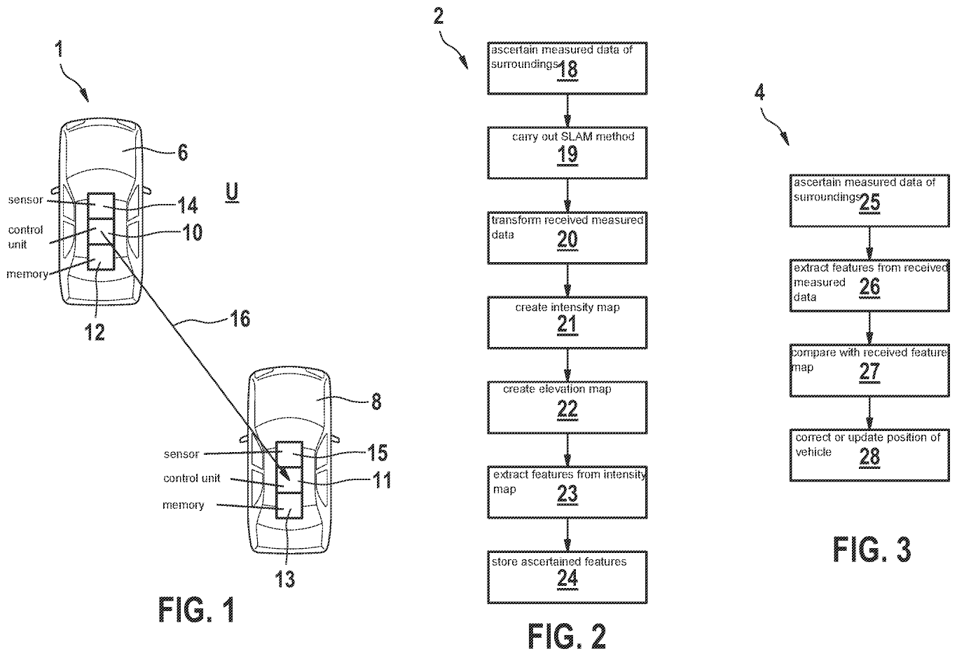

A schematic diagram for illustrating method 2 for creating digital maps according to one exemplary embodiment is shown in FIG. 2.

In a first step 18, measured data of surroundings U are ascertained during a measuring run of first vehicle 6 and received by control unit 10. According to the exemplary embodiment, surroundings U are scanned with a LIDAR sensor 14.

In a subsequent step 19, a SLAM method is carried out during the measuring run based on the received measured data. A trajectory of first vehicle 6 is ascertained with the aid of the SLAM method.

The received measured data are transformed 20 into a coordinate system of the trajectory. Alternatively, the trajectory may be transformed into a coordinate system of the measured data. For example, the shared coordinate system may be a Cartesian coordinate system.

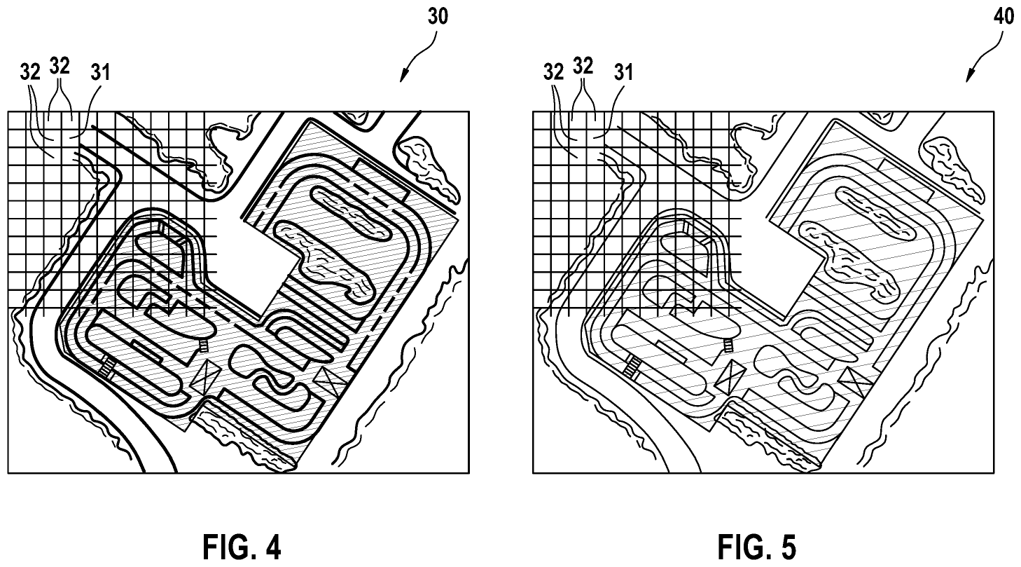

An intensity map 30 is created 21 based on the transformed measured data. Such an intensity map 30 is illustrated in FIG. 4. The measured data may be present, in particular, as a grid map including a plurality of cells 31, 31. Cells 31, 32 may, for example, be designed as pixels or as pixel groups. Each cell 31, 32 may include in accordance with the coordinate system a local assignment such as, for example, GPS coordinates.

An intensity is subsequently calculated for each cell 31, 32. For this purpose, a mean value is calculated for all measured values within respective cell 31, 32. An intensity map 30 is thus formed 21 from the calculated mean values.

An elevation map 40 is also created 22. Elevation map 40 is created from the weighted mean values and is shown in FIG. 5. The weighted mean values are calculated for the measured values within each cell 31 and for the measured data in the corresponding adjacent cells 32.

In one further step 23, features are extracted from intensity map 30. This may take place, for example, via an automated pattern recognition algorithm or manually by an employee. For example, transitions between bright and dark areas in intensity map 30 may be considered as possible patterns. Each feature may be assigned a profile based on elevation map 40.

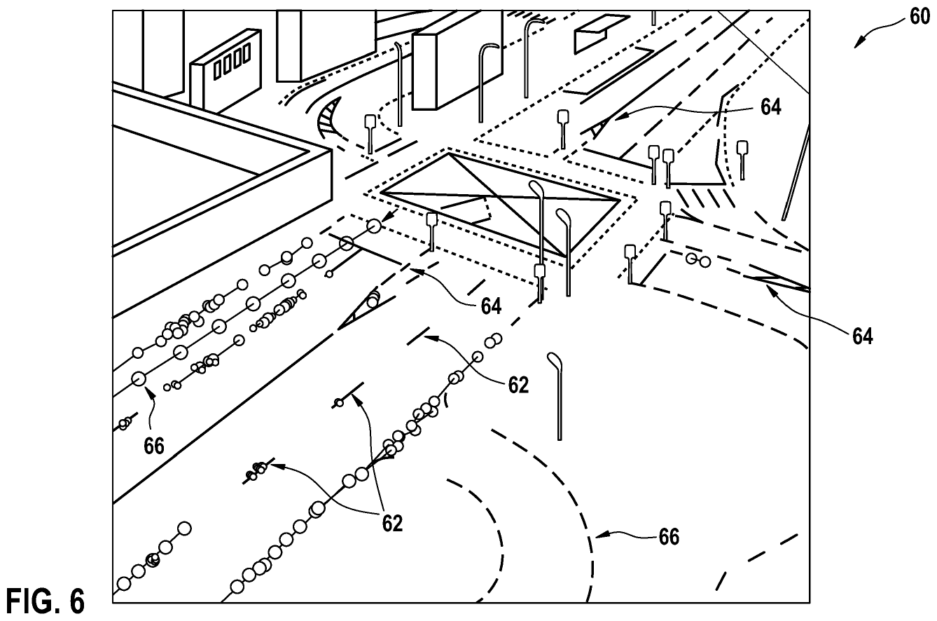

The ascertained features are stored 24 according to their position within intensity map 30 in a feature map 60. Feature map 60 is schematically illustrated in FIG. 6. In this case, an exemplary LIDAR scan is superimposed with a plurality of features 62, 64, 66. Features 62, 64, 66 are designed by way of example as lane markings 62, roadway boundaries 64 and other markings on surface 66. Feature map 60 may, for example, be stored in machine-readable memory medium 12 and be provided via communication link 16.

FIG. 3 schematically shows a diagram for illustrating method 4 for carrying out a localization according to one exemplary embodiment. Method 4 is carried out, for example, by control unit 11 of second vehicle 8.

In a step 25, measured data of surroundings U are ascertained by sensor 15 and transferred to control unit 11. Feature map 60 is also received by control unit 11 via communication link 16. This may be converted by a position diagram localizer implemented in control unit 11.

The measured data in this case may be ascertained continuously or at defined temporal intervals and may be received by control unit 11. In addition, odometric measured data may be received by control unit 11.

In a further step 26, features 62, 64, 66 are extracted from the received measured data. Features 62, 64, 66 in this case are compared 27 with received feature map 60. In the comparison, the attempt is made to find features 62, 64, 66 detected on board on feature map 60. The odometrically ascertained measured data in this case may narrow down the search area within feature map 60. Since feature map 60 includes abstracted and therefore universally useable features 62, 64, 66, the measured data ascertained using camera sensor 15 may also be used for a localization.

If matches are found between the features ascertained on board with features 62, 64, 66 in feature map 60, the position of vehicle 8 may be corrected or updated 28.

1-12. (canceled)

13. A method for creating a digital map using a control unit, the method comprising the following steps:
receiving measured data of surroundings during a measuring run;
ascertaining, using a SLAM method, a trajectory of the measuring run based on the received measured data;
transforming the received measured data into a coordinate system of the ascertained trajectory;
creating an intensity may using the transformed measured data; and
extracting features from the intensity map and storing the extracted features in a feature map.

14. The method as recited in claim 13, wherein the feature map is stored as the digital map or as a map layer of the digital map.

15. The method as recited in claim 13, wherein the received measured data are present as a point cloud and are assigned to a grid made up of a plurality of cells, median values of the measured data of each cell of the cells being formed for creating the intensity map.

16. The method as recited in claim 15, further comprising:
creating an elevation map (from the received measured data, a weighted mean value being formed from the measured data of each cell and of adjacent cells for creating the elevation map.

17. The method as recited in claim 16, wherein pieces of information from the created elevation map are received and stored in the feature map for determining an elevation of the extracted features.

18. The method as recited in claim 13, wherein the extracted features are stored as universally ascertainable features in the feature map, the features being extracted and stored as geometric shapes and/or lines and/or points and/or point clouds.

19. A method for carrying out a localization using a control unit, the method comprising:
receiving measured data of surroundings and a feature map;
recognizing and extracting features in the received measured data; and
ascertaining a position by comparing at least one of the extracted features with features stored in the feature map.

20. The method as recited in claim 19, wherein the received measured data are position data and are stored in a position diagram, the ascertained position in the case of successfully compared features being stored as a new measured value in the position diagram.

21. The method as recited in claim 19, wherein the measured data are ascertained by at least one sensor, which differs from at least one sensor, for creating the feature map.

22. A control unit configured to create a digital map using a control unit, the control unit configured to:
receive measured data of surroundings during a measuring run;
ascertain, using a SLAM method, a trajectory of the measuring run based on the received measured data;
transform the received measured data into a coordinate system of the ascertained trajectory;
create an intensity may using the transformed measured data; and
extract features from the intensity map and store the extracted features in a feature map.

23. A non-transitory machine-readable memory medium on which is stored a computer program for creating a digital map using a control unit, the computer program, when executed by computer, causing the computer to perform the following steps:
receiving measured data of surroundings during a measuring run;
ascertaining, using a SLAM method, a trajectory of the measuring run based on the received measured data;
transforming the received measured data into a coordinate system of the ascertained trajectory;
creating an intensity may using the transformed measured data; and
extracting features from the intensity map and storing the extracted features in a feature map.
